(19) United States
(12) Patent Application Publication
(10) Pub. No.: US 2007/0228977 A1
(43) Pub. Date: Oct. 4, 2007

(54) Plasma display panel and plasma display apparatus including the same

(76) Inventors: Kyoung-Doo Kang, Suwon-si (KR); Won-Ju Yi, Suwon-si (KR); Ho-Young Ahn, Suwon-si (KR); Dong-Young Lee, Suwon-si (KR); Soo-Ho Park, Suwon-si (KR); Seok-Gyun Woo, Suwon-si (KR); Jae-Ik Kwon, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/726,413

(22) Filed: Mar. 22, 2007

(30) Foreign Application Priority Data
Mar. 28, 2006 (KR) 10-2006-0028112

(51) Int. Cl. H01J 17/49

(52) U.S. Cl. 313/586; 313/587; 313/582

(57) ABSTRACT

Provided is a plasma display panel comprising a front substrate, a sealing layer that seals a discharge gas, and phosphor layers on the sealing layer without a rear substrate formed of glass, thereby improving brightness and luminous efficiency and a plasma display apparatus including the plasma display panel. The plasma display panel includes: a substrate; barrier ribs formed on the substrate and defining a plurality of discharge cells; pairs of discharge electrodes disposed in the barrier ribs and generating a discharge in the discharge cells; a sealing layer, along with the substrate, sealing the discharge cells; first phosphor layers disposed on the substrate in the discharge cells; and second phosphor layers disposed on the sealing layer in the discharge cells.

### CROSS-REFERENCE TO RELATED PATENT APPLICATION

This application claims the benefit of Korean Patent Application No. 10-2006-0028112, filed on Mar. 28, 2006, in the Korean Intellectual Property Office, the disclosure of which is incorporated herein in its entirety by reference.

### BACKGROUND OF THE INVENTION

1. Field of the Invention

The present embodiments relate to a plasma display panel, and more particularly, to a plasma display panel with a new structure including a front substrate and a sealing layer that seals a discharge gas without a rear substrate formed of glass, and a plasma display apparatus comprising the plasma display panel.

2. Description of the Related Art

FIG. 1 is an exploded perspective view of a conventional plasma display panel 100. The plasma display panel 100 comprises a front substrate 101, pairs of sustain electrodes 106 and 107, a front dielectric layer 109 covering the sustain electrodes 106 and 107, a protective layer 111 on the front dielectric layer 109, a rear substrate 115 facing the front substrate 101, address electrodes 117 disposed parallel to each other on the rear substrate 115, a rear dielectric layer 113 covering the address electrodes 117, barrier ribs 114 formed on the rear dielectric layer 113, and phosphor layers 110 formed on top of the rear dielectric layer 113 and sidewalls of the barrier ribs 114.

In this regard, since the front substrate 101 and the rear substrate 115 of the conventional PDP 100 are formed of glass having several millimeters of thickness, the glass substrates are weighty and have high cost. However, since the sustain electrodes 106 and 107 and the address electrodes 117 are disposed on the front substrate 101 and the rear substrate 115, the conventional PDP 100 must use the glass substrates in spite of heavy weight and costs.

### SUMMARY OF THE INVENTION

The present embodiments provide a plasma display panel comprising a front substrate, a sealing layer that seals a discharge gas, and phosphor layers on the sealing layer without a rear substrate formed of glass that can improve brightness and luminous efficiency, and a plasma display apparatus including the plasma display panel.

According to an aspect of the present embodiments, there is provided a plasma display panel comprising: a substrate; barrier ribs formed on the substrate and defining a plurality of discharge cells; pairs of discharge electrodes disposed in the barrier ribs and generating a discharge in the discharge cells; a sealing layer, along with the substrate, sealing the discharge cells; first phosphor layers disposed on the substrate in the discharge cells; and second phosphor layers disposed on the sealing layer in the discharge cells.

The sealing layer may be formed of a dielectric substance.

The sealing layer may include at least one selected from a group consisting of SiO₂, Al₂O₃, TiO₂, BaO, CaO, B₂O₃, ZnO, R₂O, PbO, and Bi₂O₃.

The sealing layer may be formed of the same material as that of the barrier ribs.

The sealing layer may be integrally formed with the barrier ribs

The pairs of discharge electrodes may include first discharge electrodes and second discharge electrodes that extend to cross each other.

The first discharge electrodes and the second discharge electrodes may extend to surround at least a part of the discharge cells disposed in a direction.

The pairs of discharge electrodes may include first discharge electrodes and second discharge electrodes that extend parallel to each other, further comprising: address electrodes extending to cross the pairs of discharge electrodes.

The first discharge electrodes and the second discharge electrodes may oppose each other toward the discharge cells.

The first discharge electrodes and the second discharge electrodes may extend to surround at least a part of the discharge cells disposed in a direction.

The address electrodes may be immersed in the sealing layer.

Grooves with a predetermined depth may be formed on the substrate facing the discharge cells and the first phosphor layers are disposed in the grooves.

Grooves with a predetermined depth may be formed on the sealing layer facing the discharge cells and the second phosphor layers are disposed in the grooves.

According to another aspect of the present embodiments, there is provided a plasma display apparatus comprising: a substrate; barrier ribs formed on the substrate and defining a plurality of discharge cells; pairs of discharge electrodes disposed in the barrier ribs and generating a discharge in the discharge cells; a sealing layer, along with the substrate, sealing the discharge cells; first phosphor layers disposed on the substrate in the discharge cells; second phosphor layers disposed on the sealing layer in the discharge cells; and a chassis disposed in a side portion of the sealing layer and supporting the substrate.

### BRIEF DESCRIPTION OF THE DRAWINGS

The above and other features and advantages of the present embodiments will become more apparent by describing in detail exemplary embodiments thereof with reference to the attached drawings in which:

FIG. 1 is an exploded perspective view of a conventional plasma display panel;

FIG. 2 is a partially exploded perspective view of a plasma display panel according to an embodiment;

FIG. 3 is a partial cross-sectional view taken along a line III-III of FIG. 2, according to an embodiment;

FIG. 4 is a layout diagram of discharge cells and first and second discharge electrodes of the plasma display panel illustrated in FIG. 2, according to an embodiment;

FIG. 5 is a partial cross-sectional view of a plasma display panel having a three-electrode structure according to another embodiment;

FIG. 6 is a layout diagram of discharge cells, first and second discharge electrodes, and address electrodes of the plasma display panel illustrated in FIG. 5, according to an embodiment;

FIG. 7 is a layout cross-sectional view of the plasma display panel illustrated in FIG. 2 to explain a method of manufacturing the plasma display panel;

FIG. 8 is a partially exploded perspective view of a plasma display panel according to another embodiment;

FIG. 9 is a partial cross-sectional view taken along a line IX-IX of FIG. 8, according to another embodiment; and

FIG. 10 is a partial cross-sectional view of a plasma display apparatus according to another embodiment.

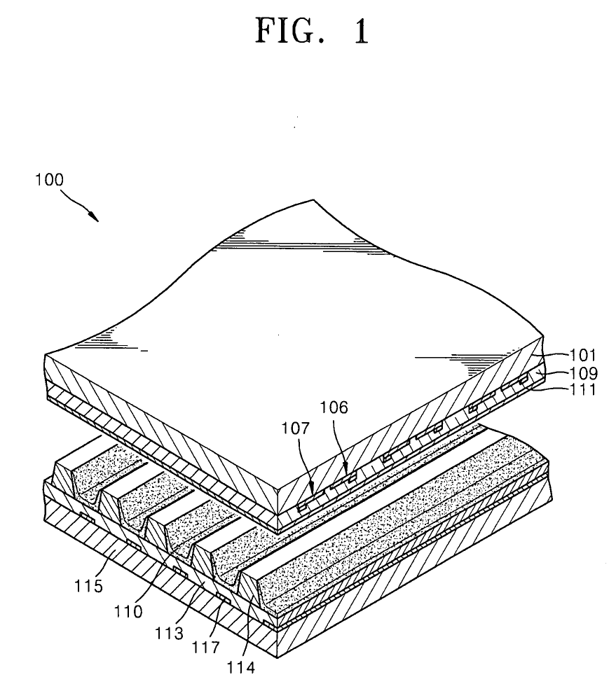

### DETAILED DESCRIPTION OF THE INVENTION

Hereinafter, the present embodiments will be described more fully with reference to the accompanying drawings, in which exemplary embodiments are shown.

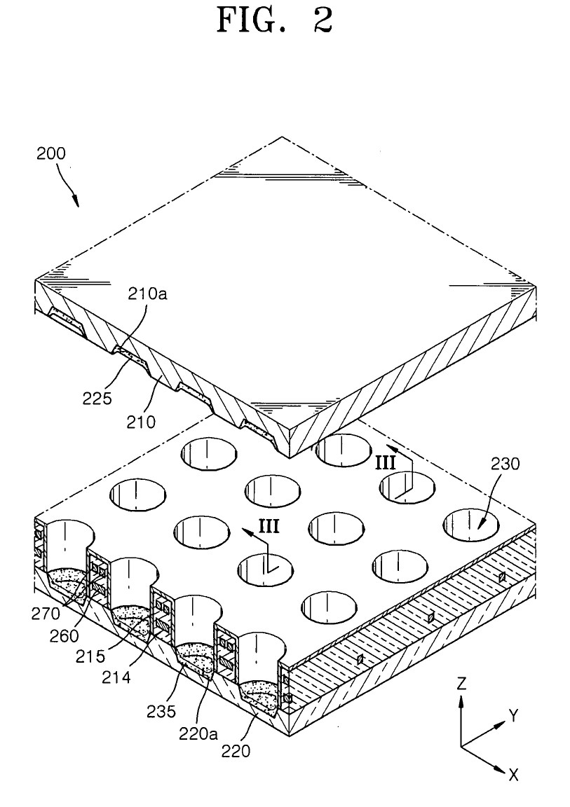

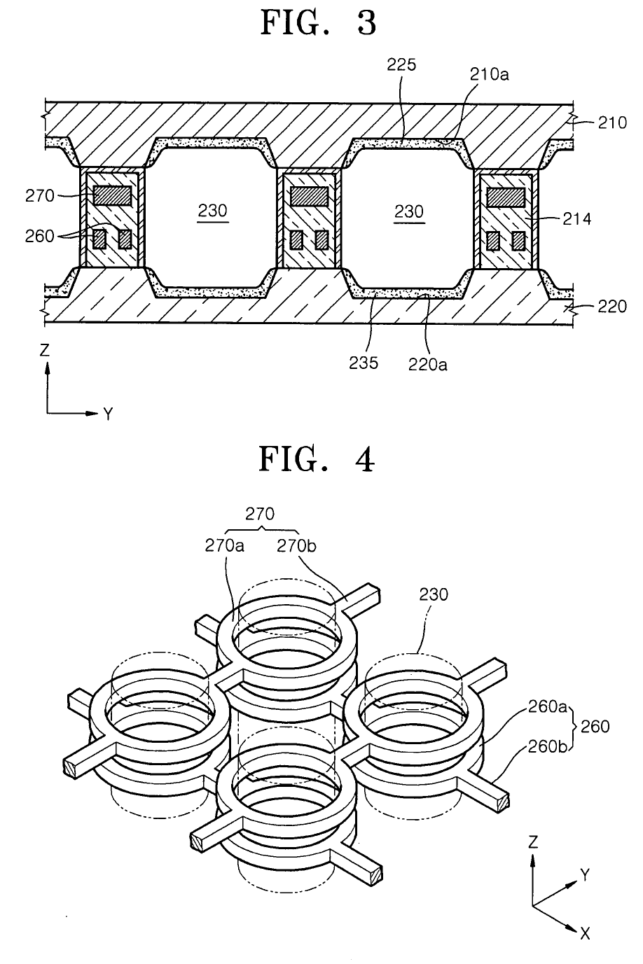

FIG. 2 is a partially exploded perspective view of a plasma display panel 200 according to an embodiment and FIG. 3 is a cross-sectional view taken along a line III-III of FIG. 2, according to an embodiment. Also, FIG. 4 is a schematic layout diagram of discharge cells 230 and first and second discharge electrodes 260 and 270, which are shown in FIG. 2, according to an embodiment.

The plasma display panel 200 includes a substrate 210, a sealing layer 220, barrier ribs 214, first discharge electrodes 260, second discharge electrodes 270, first and second phosphor layers 225 and 235, and protective layers 215.

The substrate 210 can be formed of a material having excellent light transmission properties such as glass. The substrate 210 can also be colored in order to increase the bright room contrast by reducing reflective brightness.

In the current embodiment, visible light generated in the discharge cells 230 is transmitted through the substrate 210. The sustain electrodes 106 and 107, the front dielectric layer 109, and the protective layer 111, which are disposed on the first substrate 101 of the conventional plasma display panel 100 are not disposed on the substrate 210, and thus, transmission of visible light is remarkably improved. Therefore, when the plasma display panel 200 displays an image having conventional brightness, the first and second discharge electrodes 260 and 270 can be operated at a relatively low voltage.

Referring to FIGS. 2 and 3, the barrier ribs 214 are formed on the substrate 210 to define the discharge cells 230, and prevent electrical and optical cross talk from occurring between the adjacent discharge cells 230. The discharge cells 230 defined by the barrier ribs 214 have circular cross sections, but the present embodiments are not limited thereto.

The barrier ribs 214 can have a variety of patterns to define the discharge cells 230. For example, the discharge cells 230 may have polygonal cross sections such as triangular cross sections, tetragonal cross sections, pentagonal cross sections, etc. or oval cross sections. The discharge cells 230 can have delta- or waffle-shaped arrangement.

The sealing layer 220 is formed on the bottom surface of the barrier ribs 214 to seal the discharge cells 230. The sealing layer 220 may contact the bottom surface of the barrier ribs 214. The sealing layer 220 can be formed of various materials, and may be formed of a dielectric substance. In some embodiments, the sealing layer can contain, for example, SiO₂, Al₂O₃, TiO₂, BaO, CaO, B₂O₃, ZnO, R₂O, PbO, Bi₂O₃ or a combination thereof. Also, the sealing layer 220 may be integrally formed with the barrier ribs 214, which will be described later.

The first discharge electrodes 260 and the second discharge electrodes 270 are disposed in the barrier ribs 214. The pairs of first discharge electrodes 260 and second discharge electrodes 270 generate discharge in the discharge cells 230. Each of the first discharge electrodes 260 extends to surround the discharge cells 230 disposed in a first direction X. The first discharge electrodes 260 comprise first loop parts 260a (see FIG. 4) surrounding the discharge cells 230 and first loop connection parts 260b that connect the first loop parts 260a.

In the current embodiment, the first loop parts 260a are in the shape of a circular loop but are not necessarily restricted thereto. That is, the first loop parts 260a can have a variety of shapes such as a tetragonal loop, etc. The first loop parts 260a may have the same shape as the cross sections of the discharge cells 230.

The second discharge electrodes 270 extend to surround the discharge cells 230 disposed in a second direction Y different from the first direction X in which the first discharge electrodes 260 extend. Also, the second discharge electrodes 270, formed in the barrier ribs 214, are spaced apart from each other in a direction perpendicular to (in a direction Z) the first substrate 210. According to the current embodiment, the second discharge electrodes 270 are disposed closer to the substrate 210 than the first discharge electrodes 260, but the present embodiments are not limited thereto.

The second discharge electrodes 270 comprise second loop parts 270a surrounding the discharge cells 230 and second loop connection parts 270b that connect the second loop parts 270a. In the current embodiment, the second loop parts 270a are in the shape of a circular ring but are not necessarily restricted thereto. That is, the second loop parts 270a can have a variety of shapes such as a tetragonal loop, etc. The second loop parts 270a may have the same shape as the cross sections of the discharge cells 230.

The plasma display panel 200 according to the current embodiment has a two-electrode structure. Accordingly, either the first discharge electrodes 260 or the second discharge electrodes 270 can serve as scan and sustain electrodes, and the others can serve as address and sustain electrodes. However, the present embodiments can also have a three-electrode structure.

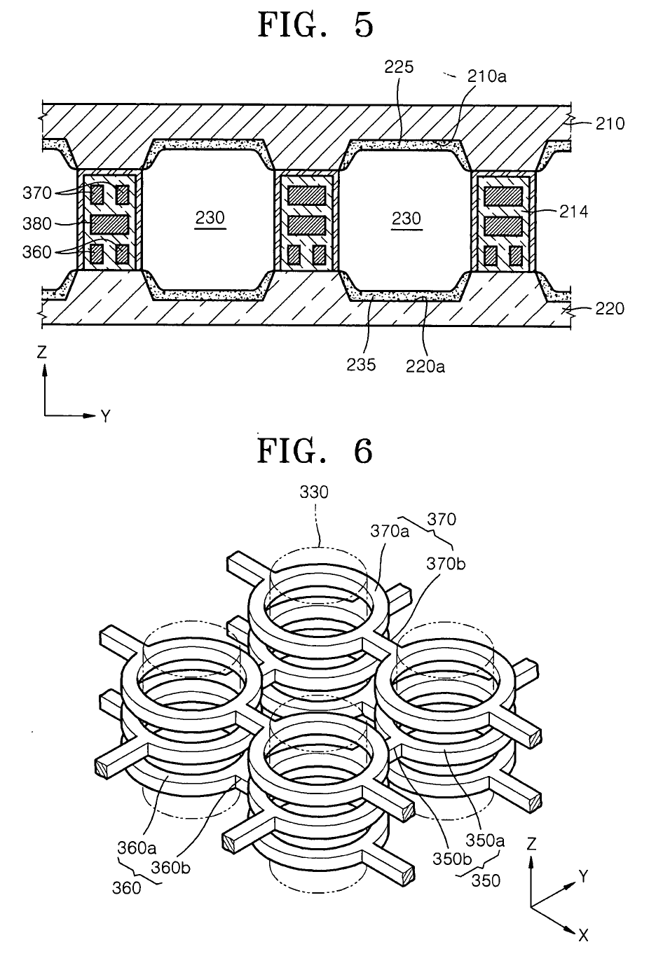

FIG. 5 is a partial cross-sectional view of a plasma display panel having a three-electrode structure according to another embodiment. FIG. 6 is a layout diagram of discharge cells 330, first and second discharge electrodes 360 and 370, and address electrodes 350 of the plasma display panel illustrated in FIG. 5 according to an embodiment. Like reference numerals in the drawings denote like elements. The pairs of first discharge electrodes 360 and second discharge electrodes 370 generate discharge in discharge cells 330, and extend parallel to each other.

The first discharge electrodes 360 comprise first loop parts 360a surrounding the discharge cells 330 disposed in a first direction X and first loop connection parts 360b that connect the first loop parts 360a. The second discharge electrodes 370 comprise first loop parts 370a surrounding the discharge cells 330 disposed in the first direction X and first loop connection parts 370b that connect the first loop parts 370a. The plasma display panel having the three-electrode structure comprises the address electrodes 350 that cross the first discharge electrodes 360 and the second discharge electrodes 370.

The address electrodes 350, formed in the barrier ribs 214, are spaced apart from each other in a direction perpendicular to (in a direction Z) the first and second discharge electrodes 360 and 370 and the substrate 210. The address electrodes 350 comprise third loop parts 350a surrounding the discharge cells 330 and third loop connection parts 350b that connect the first loop parts 350a. In the current embodiment, the second discharge electrodes 370, the address electrodes 350, and the first discharge electrodes 360 are sequentially disposed perpendicularly to the substrate 210 to reduce an address discharge voltage, but the present embodiments are not limited thereto.

The address electrodes 350 can be disposed close to the substrate 210, or fart from the substrate 210, and can be formed in the sealing layer 220. The address electrodes 350 generate an address discharge in order to more easily perform a sustain discharge between the first discharge electrodes 360 and the second discharge electrodes 370, and more particularly, to reduce a voltage required to start the sustain discharge.

The address discharge is performed between scan electrodes and address electrodes. If the address discharge is finished, positive ions are accumulated on the scan electrodes, and electrons are accumulated on sustain electrodes, so that the sustain discharge is easily performed between the scan electrodes and the sustain electrodes. In the current embodiment, the first discharge electrodes 360 serve as the scan electrodes and the second discharge electrodes 370 serve as the sustain electrodes, but the present embodiments are not limited thereto.

Referring to FIGS. 2 and 3, since the first discharge electrodes 260 and the second discharge electrodes 270 are disposed in the barrier ribs 214, they do not reduce the transmission rate of visible light. Therefore, the first discharge electrodes 260 and the second discharge electrodes 270 may be formed of a conductive metal such as aluminum, copper, etc. Accordingly, since the conductive metal has a small voltage drop, the first discharge electrodes 260 and the second discharge electrodes 270 can transmit signals stably.

Since the first discharge electrodes 260 and the second discharge electrodes 270 are immersed in the barrier ribs 214, the barrier ribs 214 prevent direct conduction between the first discharge electrodes 260 and the second discharge electrodes 270 and the first discharge electrodes 260 and the second discharge electrodes 270 from being damaged due to direct collisions of positive ions and electrons with the first and second electrodes 260 and 270. Also, the barrier ribs 214 accumulate wall charges by inducing charges. Accordingly, the barrier ribs 214 may be formed of a dielectric substance.

The protective layers 215 are formed on portions of sidewalls and top surface of the barrier ribs 214. The protective layers 215 prevent the barrier ribs 214 formed of the dielectric substance and the first and second discharge electrodes 260 and 270 from being damaged due to sputtering of plasma particles. Also, the protective layers 215 generate secondary electrons which can reduce discharge voltage. The protective layers 215 can be formed by coating a material such as magnesium oxide (MgO) with a predetermined thickness on the sidewalls and the top surface of the barrier ribs 214.

Phosphor layers include the first phosphor layers 225 and the second phosphor layer 235. First grooves 210a (see FIG. 3) with a predetermined depth are formed on the substrate 210 facing the discharge cells 230. The first grooves 210a are discontinuously formed in each of the discharge cells 230. The first phosphor layers 225 are disposed in the first grooves 210a.

Second grooves 220a with a predetermined depth are formed on the sealing layer 220 facing the discharge cells 230. The second grooves 210a are discontinuously formed in each of the discharge cells 230. The second phosphor layers 235 are disposed in the second grooves 220a.

The phosphor layers 225 are formed on the substrate 210 through which light transmits and on the sealing layer 220 sealing the discharge cells 230, which increases brightness and luminous efficiency.

The arrangement of the first and second phosphor layers 225 and 235 are not restricted thereto but can also have a variety of modifications. For example, the first and second phosphor layers 225 and 235 can be disposed on the sidewalls of the barrier ribs 214 in which the protective layers 215 are not formed. The first and second phosphor layers 225 and 235 have a component generating visible rays with ultraviolet rays. That is, a phosphor layer formed in a red light-emitting discharge cell has a phosphor such as Y(V,P)O₄:Eu, a phosphor layer formed in a green light-emitting discharge cell has a phosphor such as Zn₂SiO₄:Mn, YBO₃:Tb, and a phosphor layer formed in a blue light-emitting discharge cell has a phosphor such as BAM:Eu.

A discharge gas such as Ne, Xe, or a mixture thereof is sealed in the discharge cells 330. In the current embodiment, a discharge surface increases and a discharge area can be expanded, thereby increasing an amount of plasma, so that the plasma display panel 200 can be operated at a low voltage. Therefore, although a gas Xe having a high density can be used as the discharge gas, the plasma display panel 200 can be operated at a low voltage, thereby remarkably increasing luminous efficiency, which solves the disadvantage of the conventional plasma display panel that cannot be operated at a low voltage when gas Xe having high density is used as the discharge gas.

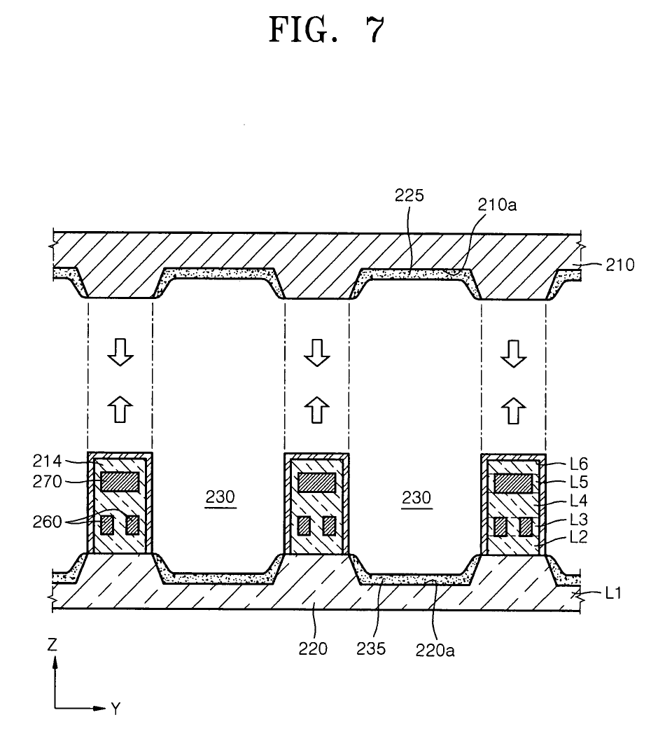

A method of operating the plasma display panel 200 will now be described with reference to FIG. 7.

A flat substrate is provided and is etched and sandblasted, and the first grooves 210a are formed, thereby forming the substrate 210. Thereafter, the first grooves 210a are coated with phosphor pastes, and the phosphor pastes are dried and baked, thereby forming the first phosphor layers 225.

A process of forming a barrier rib sheet is also performed. The barrier rib sheet includes the barrier ribs 214, the sealing layer 220, the first and second discharge electrodes 260 and 270, and the protective layers 215.

A first dielectric sheet L1 (see FIG. 7) for the sealing layer 220 is provided. A flat dielectric sheet is etched and sandblasted, and the second grooves 220a are formed, thereby forming the first dielectric sheet L1. Thereafter, the second grooves 220a are coated with the phosphor pastes, and the phosphor pastes are dried and baked, thereby forming the second phosphor layers 235.

Dielectric sheets are stacked on the first dielectric sheet L1 to form the barrier ribs 214. A second dielectric sheet L2 is provided. A third dielectric sheet L3 in which the first discharge electrodes 260 are patterned is stacked on the second dielectric sheet L2.

A fourth dielectric sheet L4 is stacked on the third dielectric sheet L3. A fifth dielectric sheet L5 in which the second discharge electrodes 270 are patterned is stacked on the fourth dielectric sheet L4. A sixth dielectric sheet L6 is stacked on the fifth dielectric sheet L5. After the second, third, fourth, fifth, and sixth dielectric sheets L2, L3, L4, L5, and L6 are stacked on the first dielectric sheet L1, a punching process is performed in portions where the discharge cells 230 are disposed to form discharge spaces.

After the punching process is performed, the second, third, fourth, fifth, and sixth dielectric sheets L2, L3, L4, L5, and L6 are dried and baked to form the barrier rib sheet comprising the barrier ribs 214 and the sealing layer 220. The discharge cells 230 are masked and MgO is sputtered to form the protective layers 215. Each of the dielectric sheets L1, L2, L3, L4, L5, and L6 is a single sheet but the present embodiments are not necessarily restricted thereto. Each of the dielectric sheets L1, L2, L3, L4, L5, and L6 can be a plurality of sheets.

After the barrier rib sheet is formed, the substrate 210 and the barrier rib sheet are aligned and a sealing process is performed using frit, and the like. Thereafter, exhaust/discharge gas injection processes are continuously performed to manufacture the plasma display panel 200. Thereafter, a variety of post-processes such as aging, and the like, can be performed.

The plasma display panel of the current embodiment can be easily manufactured since the barrier ribs 214 and the sealing layer 220 are integrally formed and similar processes are separated.

A method of operating the plasma display panel 200 having the above structure will now be described.

The address discharge is generated between the first discharge electrodes 260 and the second discharge electrodes 270 so that the discharge cells 230 in which the sustain discharge is generated are selected. If a sustain voltage is applied between the first discharge electrodes 260 and the second discharge electrodes 270 of the selected discharge cells 230, the sustain discharge is generated between the first discharge electrodes 260 and the second discharge electrodes 270. The sustain discharge reduces the energy level of an excited discharge gas and thus ultraviolet rays are emitted. The ultraviolet rays excite the first and second phosphor layers 225 and 235, the energy level of the excited first and second phosphor layers 225 and 235 are reduced, a visible light is emitted, and the emitted visible light forms an image.

The conventional plasma display panel 100 has a relatively small discharge area due to the sustain discharge generated perpendicularly to the first substrate 101 between the sustain electrodes 106 and 107, compared to the plasma display panel 200 of the present embodiments. However, the plasma display panel 200 of the present embodiments has a relatively large discharge area due to the sustain discharge generated on all sides of the discharge cells 230.

Also, in the current embodiment, the sustain discharge forms a closed curve along the sidewalls of the barrier ribs 214 and gradually extends to the center of each of the discharge cells 230. Accordingly, the size of the sustain discharge area increases, and space charges of the discharge cells 230 which are not conventionally used contribute to light-emission, thereby improving luminous efficiency of the plasma display panel. In particular, since the discharge cells 230 have circular cross sections, the sustain discharge is uniformly generated in all sides of the discharge cells 230.

Also, the sustain discharge is generated mainly at the center of each of the discharge cells 230, which prevents ion sputtering of the phosphor layers 225 that is a disadvantage of the conventional plasma display panel 100. Accordingly, image sticking does not occur even when an image is displayed for a long time.

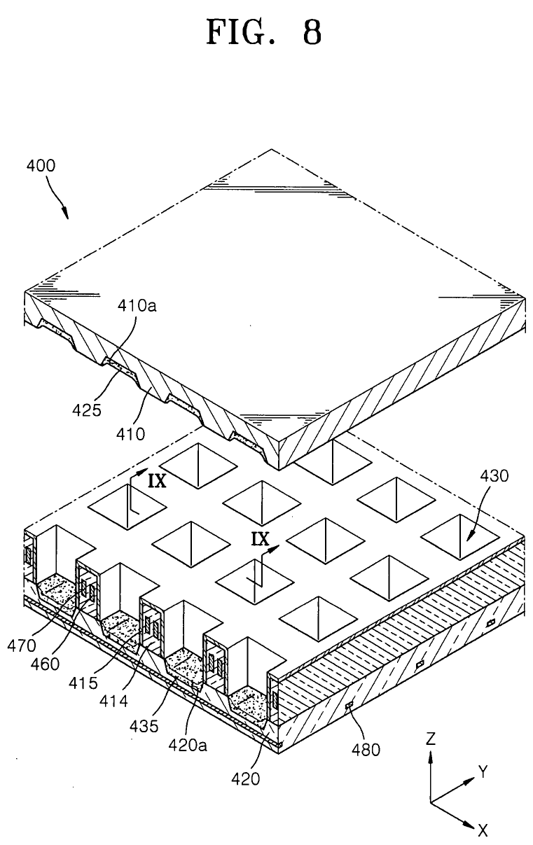

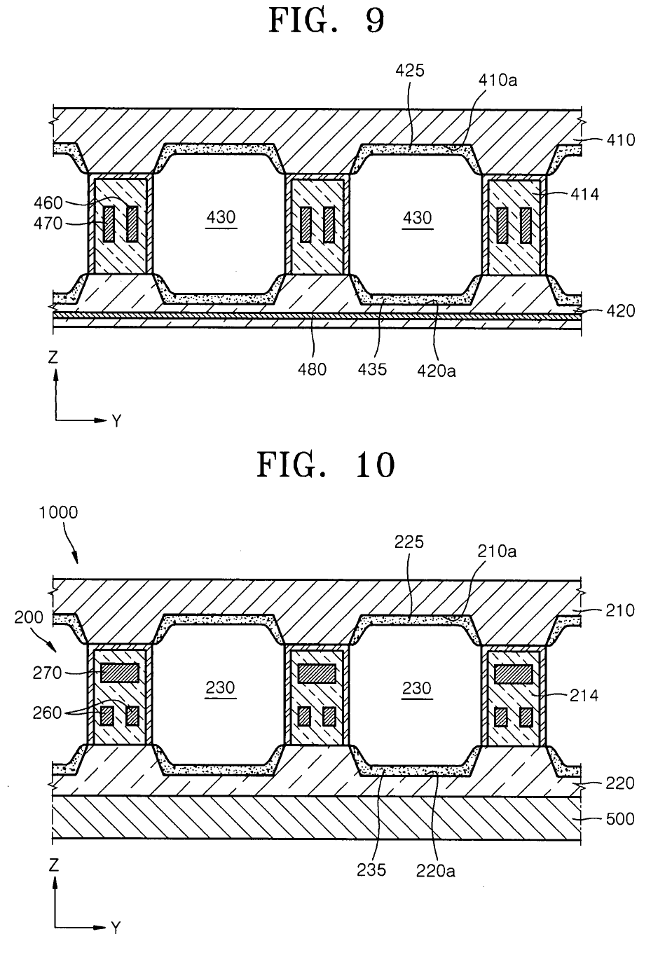

FIG. 8 is a partially exploded perspective view of a plasma display panel 400 according to another embodiment. FIG. 9 is a partial cross-sectional view taken along a line IX-IX of FIG. 8, according to another embodiment.

The plasma display panel 400 includes a substrate 410, a sealing layer 420, barrier ribs 414, first discharge electrodes 460, second discharge electrodes 470, address electrodes 480, phosphor layers 425 and 435, and protective layers 415.

The difference between the plasma display panel 200 of the previous embodiment and the plasma display panel 400 of the current embodiment is that the pairs of the first discharge electrodes 460 and second discharge electrodes 470 have an opposed discharge structure. The plasma display panel 400 of the current embodiment will now be described based on the differences.

The substrate 410 is normally formed of a material having excellent light transmission properties such as glass. Also, the substrate 410 can be colored in order to increase the bright room contrast by reducing reflective brightness.

Referring to FIGS. 8 and 9, the barrier ribs 414 are formed on the substrate 410 to define the discharge cells 430, and prevent electrical and optical cross talk from occurring between the adjacent discharge cells 430. The discharge cells 430 defined by the barrier ribs 414 have tetragonal cross sections, but the present embodiments are not limited thereto.

The sealing layer 420 is formed on the bottom surface of the barrier ribs 414 to seal the discharge cells 430. The sealing layer 420 may contact the bottom surface of the barrier ribs 414. The sealing layer 420 can be formed of various materials, and may be formed of a dielectric substance. Also, the sealing layer 420 may be integrally formed with the barrier ribs 414.

The first discharge electrodes 460 and the second discharge electrodes 470 are disposed in the barrier ribs 414. The pairs of first discharge electrodes 460 and second discharge electrodes 470 generate discharge in the discharge cells 430. The first discharge electrodes 460 and the second discharge electrode 470 extend, are stripe-shaped in a first direction Y, and are spaced apart from each other facing the discharge cells 460.

Since the first discharge electrodes 460 and the second discharge electrodes 470 have the opposed discharge structure, a discharge is uniformly generated in the discharge cells 430.

The address electrodes 480 that extend in a second direction X and cross the first discharge electrodes 460 and the second discharge electrodes 470 are disposed in the sealing layer 420. In the current embodiment, since the address electrodes 480 are disposed in the sealing layer 420 formed of the dielectric substance, the address electrodes 480 are prevented from being damaged due to the discharge.

In the current embodiment, the first discharge electrodes 460 serve as scan electrodes and the second discharge electrodes 470 serve as sustain electrodes, but the present embodiments are not limited thereto.

Since the first discharge electrodes 460 and the second discharge electrodes 470 are immersed in the barrier ribs 414, the barrier ribs 414 prevent direct conduction between the first discharge electrodes 460 and the second discharge electrodes 470 and the first discharge electrodes 460 and the second discharge electrodes 470 from being damaged due to direct collisions of positive ions and electrons with the first and second discharge electrodes 460 and 470. Also, the barrier ribs 414 accumulate wall charges by inducing charges. Accordingly, the barrier ribs 414 may be formed of a dielectric substance.

The protective layers 415 are formed on portions of sidewalls and top surface of the barrier ribs 414. The protective layers 415 can be formed by coating magnesium oxide (MgO), for example, on the sidewalls and the top surface of the barrier ribs 414.

Phosphor layers include the first phosphor layers 425 and the second phosphor layer 435. First grooves 410a with a predetermined depth are formed on the substrate 410 facing the discharge cells 430. The first grooves 410a are discontinuously formed in each of the discharge cells 430. The first phosphor layers 425 are disposed in the first grooves 410a.

Second grooves 420a with a predetermined depth are formed on the sealing layer 420 facing the discharge cells 430. The second grooves 420a are discontinuously formed in each of the discharge cells 430. The second phosphor layers 435 are disposed in the second grooves 420a.

The phosphor layers 425 are formed on the substrate 410 through which light transmits and on the sealing layer 420 sealing the discharge cells 430, which increases brightness and luminous efficiency.

A discharge gas such as Ne, Xe, or a mixture thereof is sealed in the discharge cells 430.

A method of manufacturing the plasma display panel 400 of the current embodiment is similar to the plasma display panel 200 of the previous embodiment, and thus its description is omitted.

A method of operating the plasma display panel 400 having the above structure will now be described.

An address discharge is generated between the first discharge electrodes 460 and the address electrodes 480, resulting in the selection of the discharge cells 430 that generate a sustain discharge. Thereafter, when a sustain voltage is applied between the first discharge electrodes 460 and the second discharge electrodes 470 of the selected discharge cells 430, the sustain discharge is generated between the first and second discharge electrodes 460 and 470. An energy level of the discharge gas excited by the sustain discharge is reduced, thereby discharging ultraviolet rays. The ultraviolet rays excite the phosphor layers 425, such that an energy level of the excited phosphor layers 425 is reduced to discharge visible light that forms an image.

FIG. 10 is a partial cross-sectional view of a plasma display apparatus 1000 according to another embodiment. Referring to FIG. 10, the plasma display apparatus 1000 of the current embodiment comprises the plasma display panel 200 and a chassis 500 disposed in the rear of the sealing layer 220 of the plasma display panel 200. The chassis 500 dissipates heat transferred from the plasma display panel 200 and structurally supports the plasma display panel 200. An operating part (not shown) for operating the plasma display panel 200 can be formed in a portion of the chassis 500.

In the current embodiment, the plasma display apparatus 1000 comprises the plasma display panel 200 but the present embodiments are not necessarily restricted thereto. The plasma display apparatus 1000 can comprise any plasma display panels according to the present embodiments including the plasma display panel 400.

Since the plasma display apparatus 1000 does not require a rear substrate unlike general plasma display apparatuses, the weight of the plasma display apparatus 1000 and manufacturing costs thereof are reduced. The plasma display apparatus 1000 can also be easily manufactured.

The plasma display panel 200 and the chassis 500 contact each other but the present embodiments are not necessarily restricted thereto. A thermal conductive sheet can be disposed between the sealing layer 220 and the chassis 500 to dissipate heat generated by the plasma display panel 200 or transfer the heat to the chassis 500. Also, a bonding member such as a double-sided tape can be disposed between the chassis 500 and the sealing layer 220 to increase a mechanical fixing power between the plasma display panel 200 and the chassis 500.

According to the present embodiments, the plasma display panel and the plasma display apparatus including the plasma display panel comprise a front substrate, a sealing layer that seals a discharge gas, and phosphor layers on the sealing layer without a rear substrate formed of glass, thereby improving brightness and luminous efficiency.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A plasma display panel comprising:
a substrate;
barrier ribs formed on the substrate configured to define a plurality of discharge cells;
pairs of discharge electrodes disposed in the barrier ribs configured to generate a discharge in the discharge cells;
a sealing layer configured to seal the discharge cells;
first phosphor layers disposed on the substrate in the discharge cells; and
second phosphor layers disposed on the sealing layer in the discharge cells.

2. The plasma display panel of claim 1, wherein the sealing layer is formed of a dielectric substance.

3. The plasma display panel of claim 2, wherein the sealing layer includes at least one selected from a group consisting of SiO₂, Al₂O₃, TiO₂, BaO, CaO, B₂O₃, ZnO, R₂O, PbO, Bi₂O₃ and a combination thereof.

4. The plasma display panel of claim 1, wherein the sealing layer is formed of the same material as that of the barrier ribs.

5. The plasma display panel of claim 1, wherein the sealing layer is integrally formed with the barrier ribs.

6. The plasma display panel of claim 1, wherein the pairs of discharge electrodes include first discharge electrodes and second discharge electrodes that extend to cross each other.

7. The plasma display panel of claim 6, wherein the first discharge electrodes and the second discharge electrodes extend to surround at least a part of the discharge cells disposed in a direction.

8. The plasma display panel of claim 1, further comprising address electrodes extending to cross the pairs of discharge electrodes, wherein the pairs of discharge electrodes include first discharge electrodes and second discharge electrodes that extend parallel to each other,

9. The plasma display panel of claim 8, wherein the first discharge electrodes and the second discharge electrodes oppose each other toward the discharge cells.

10. The plasma display panel of claim 8, wherein the first discharge electrodes and the second discharge electrodes extend to surround at least a part of the discharge cells disposed in a direction.

11. The plasma display panel of claim 8, wherein the address electrodes are immersed in the sealing layer.

12. The plasma display panel of claim 1, further comprising grooves with a predetermined depth formed on the substrate facing the discharge cells, wherein the first phosphor layers are disposed in the grooves.

13. The plasma display panel of claim 1, further comprising grooves with a predetermined depth formed on the sealing layer facing the discharge cells, wherein the second phosphor layers are disposed in the grooves.

14. A plasma display apparatus comprising:
a substrate;
barrier ribs formed on the substrate configured to define a plurality of discharge cells;
pairs of discharge electrodes disposed in the barrier ribs configured to generate a discharge in the discharge cells;
a sealing layer configured to seal the discharge cells;
first phosphor layers disposed on the substrate in the discharge cells;
second phosphor layers disposed on the sealing layer in the discharge cells; and
a chassis disposed in a side portion of the sealing layer configured to support the substrate.

15. The plasma display apparatus of claim 14, wherein the sealing layer is formed of a dielectric substance.

16. The plasma display apparatus of claim 15, wherein the sealing layer includes at least one selected from a group consisting of SiO₂, Al₂O₃, TiO₂, BaO, CaO, B₂O₃, ZnO, R₂O, PbO, Bi₂O₃ and a combination thereof.

17. The plasma display apparatus of claim 14, wherein the sealing layer is formed of the same material as that of the barrier ribs.

18. The plasma display apparatus of claim 14, wherein the sealing layer is integrally formed with the barrier ribs.

19. The plasma display apparatus of claim 14, wherein the pairs of discharge electrodes include first discharge electrodes and second discharge electrodes that extend to cross each other.

20. The plasma display apparatus of claim 19, wherein the first discharge electrodes and the second discharge electrodes extend to surround at least a part of the discharge cells disposed in a direction.

21. The plasma display apparatus of claim 14, further comprising: address electrodes extending to cross the pairs of discharge electrodes, wherein the pairs of discharge electrodes include first discharge electrodes and second discharge electrodes that extend parallel to each other,

22. The plasma display apparatus of claim 21, wherein the first discharge electrodes and the second discharge electrodes oppose each other toward the discharge cells.

23. The plasma display apparatus of claim 21, wherein the first discharge electrodes and the second discharge electrodes extend to surround at least a part of the discharge cells disposed in a direction.

24. The plasma display apparatus of claim 21, wherein the address electrodes are immersed in the sealing layer.

25. The plasma display apparatus of claim 14, further comprising grooves with a predetermined depth formed on the substrate facing the discharge cells, wherein the first phosphor layers are disposed in the grooves.

26. The plasma display apparatus of claim 14, further comprising grooves with a predetermined depth formed on the sealing layer facing the discharge cells, wherein the second phosphor layers are disposed in the grooves.
